(19) United States
(12) Patent Application Publication
(10) Pub. No.: US 2019/0236285 A1
(43) Pub. Date: Aug. 1, 2019

(54) SYSTEM AND METHOD FOR A PHYSICAL DEVICE AUTHORIZING DIGITAL COPIES

(71) Applicant: Walmart Apollo, LLC, Bentonville, AR (US)

(72) Inventors: Robert CANTRELL, Herndon, VA (US); John J. O'BRIEN, Farmington, AR (US); Brian MCHALE, Oldham (GB)

(73) Assignee: Walmart Apollo, LLC, Bentonville, AR (US)

(21) Appl. No.: 16/262,615

(22) Filed: Jan. 30, 2019

Related U.S. Application Data
(60) Provisional application No. 62/624,715, filed on Jan. 31, 2018.

(51) Int. Cl. G06F 21/60; G06F 21/34; G06F 21/62; G06F 21/32; H04L 9/08; H04L 9/06

(52) U.S. Cl. CPC G06F 21/602; G06F 21/34; G06F 21/6209; H04L 9/0643; H04L 9/0866; H04L 9/0822; G06F 21/32

(57) ABSTRACT

Systems, methods, and computer-readable storage media for a physical device authorizing digital copies. When a request for the generation of a digital copy is received, the computer system first performs a physical verification of a physical key. If the key matches the authorized key(s) on record, a verification of a private or private key (used for asymmetrical cryptography), which is stored in memory in the physical key, is performed. If verification of the physical key and digital verification of the private/public key are confirmed, the duplication process is allowed to proceed, and a hash function output is added to the digital copy.

### PRIORITY

The present disclosure claims priority to U.S. Provisional Application No. 62/624,715, filed Jan. 31, 2018, the contents of which are incorporated herein in their entirety.

### BACKGROUND

### 1. Technical Field

The present disclosure relates to a system and method for preventing digital piracy and forgery, and more specifically to using a physical key with accompanying asymmetrical digital encryption to prevent prohibited duplication of digital materials.

### 2. Introduction

Digital content, such as digital movies, music, books, papers, etc., can easily be copied. While digital encryption can make access and copying difficult, it cannot prevent copying if the encryption is broken or otherwise compromised. Digital watermarking and date stamping can verify document integrity and date of production, but it cannot prevent copying. In fact, copying remains a problem if the document can be displayed at all since a displayed document can be photographed off a computer screen. As tools for accessing and stealing IP become more sophisticated, tools to prevent or discourage IP theft either by blocking theft or helping enforcers track the source become more important.

### SUMMARY

A method which may be performed according to the principles of this disclosure can include: receiving, at a processor, an identification associated with a specific piece of digital content, the specific piece of digital content comprising digital content and a hash function output; receiving, at the processor, a request to duplicate the specific piece of digital content; identifying, based on the specific piece of digital content and the hash function output, a private alphanumeric key required to duplicate the specific piece of digital content; identifying an identify of a physical key comprising a non-transitory memory device which stores the private alphanumeric key; detecting a presence of an object at a location associated with the physical key; verifying, based on physical characteristics of the object, that the object is the physical key, to yield a first verification; verifying, after the first verification, that the object contains a non-transitory computer-readable storage medium storing the private alphanumeric key, to yield a second verification; and generating, in response to the request and based on the first verification and the second verification, a copy of the specific piece of digital content comprising a hash function output specific to the copy.

A system configured according to the concepts disclosed herein can include: a processor; and a computer-readable storage medium having instructions stored which, when executed by the processor, cause the processor to perform operations comprising: receiving an identification associated with a specific piece of digital content, the specific piece of digital content comprising digital content and a hash function output; receiving a request to duplicate the specific piece of digital content; identifying, based on the specific piece of digital content and the hash function output, a private alphanumeric key required to duplicate the specific piece of digital content; identifying an identify of a physical key comprising a non-transitory memory device which stores the private alphanumeric key; detecting a presence of an object at a location associated with the physical key; verifying, based on physical characteristics of the object, that the object is the physical key, to yield a first verification; verifying, after the first verification, that the object contains a non-transitory computer-readable storage medium storing the private alphanumeric key, to yield a second verification; and generating, in response to the request and based on the first verification and the second verification, a copy of the specific piece of digital content comprising a hash function output specific to the copy.

A non-transitory computer-readable storage medium configured according to this disclosure can store instructions which, when executed by a computing device, cause the computing device to perform operations which can include: receiving an identification associated with a specific piece of digital content, the specific piece of digital content comprising digital content and a hash function output; receiving a request to duplicate the specific piece of digital content; identifying, based on the specific piece of digital content and the hash function output, a private alphanumeric key required to duplicate the specific piece of digital content; identifying an identify of a physical key comprising a non-transitory memory device which stores the private alphanumeric key; detecting a presence of an object at a location associated with the physical key; verifying, based on physical characteristics of the object, that the object is the physical key, to yield a first verification; verifying, after the first verification, that the object contains a non-transitory computer-readable storage medium storing the private alphanumeric key, to yield a second verification; and generating, in response to the request and based on the first verification and the second verification, a copy of the specific piece of digital content comprising a hash function output specific to the copy.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of digital content being legally and illegally copied;

FIG. 2 illustrates a physical key with memory being used to access a legal version of intellectual property;

FIG. 3 illustrates an exemplary method embodiment; and

FIG. 4 illustrates a computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Digital IP (Intellectual Property), such as music, private written records, manuscripts, lab notebooks, photographs, video, computer code, 3d printing templates, etc., has various legal protections in different jurisdictions. Within the United States, for example, these creations may be subject to copyright and/or trade secret protection. Despite these legal protections, the amount of illegal digital piracy continues to increase. The concepts disclosed herein provide a mechanism for improving the security associated with digital IP by requiring both physical and digital verification prior to legal duplication of content. This dual verification system can require that those who create or own content have a private key used for asymmetrical encryption (such as blockchain systems) which is stored in memory embedded within a physical key. The creator/owner's private key is used as input into a hash function, the output of which is combined with the digital IP. When a consumer legally purchases digital IP, a new hash function output is generated based on the previous hash function output, the consumer's private key, and other ancillary data (such as the time of the purchase, etc.).

Over time, this process allows a chain to be created which allows a computer system which has access/knowledge of the users and their private/public keys, to trace back every copy of any given piece of digital IP. Likewise, it may deter some digital piracy. However, when digital piracy does occur, this process will allow the immediate identification of pirated material, because either the hash function output will match that of a previous owner, or the hash function output will not correspond to any known owner.

In some configurations, the chain may be a blockchain, with each legal duplication adding to a distributed ledger, which is independently verified by other computer systems before a block corresponding to the new ownership is added to the ledger. In other cases, the chain may be a blockchain, but not use a distributed ledger and/or distributed verification of new blocks. The computer system may retain a list of private and/or public keys used for the asymmetrical encryption and hash functions used herein.

Those creating a legal copy of a product will have a private key for this asymmetrical encryption which is stored in a physical key. This key can be in any shape or size required by particular circumstance. For example, in some configurations, the key may be a simple memory stick, where the private key is stored in the memory of the memory stick. In other configurations, the key may be a key configured to operate in rotating locks, with cuts configured to interact with pins/tumblers to open a lock. Systems configured as disclosed herein may rely on both physical verification of the key (that is, does the key match the physical characteristics of the key on file?) and a digital verification of the private key stored in non-transitory memory within the key (that is, the private key, or a public key based on the private key, will be verified against the computer system records). The physical key can operate as a physical wallet for a digital record, holding a representative token (the private key), which can be used to verify records (i.e., used in conjunction with a public key stored in a computer system) of the product.

In some cases, additional verification may be required. For example, the user's biometric data (fingerprint, retinal scan, palm scan, etc.) may be used as yet a further point of verification that the duplication is being requested by an authorized individual. Yet another way in which verification can occur is through the use of location data associated with the physical key. The key may provide GPS (Global Positioning System), triangulation, RFID (Radio Frequency Identification), or other data indicating that the key being presented at the computer system has location coordinates corresponding to the key of record (for example, if the key of record is showing that it is in the Bahamas, and the key is being physically presented in New York, the verification should fail).

Consider the following example. If a consumer purchases a song or book, the song or book may be given a blockchain code unique to that copy. Any time that file is copied or transferred, it receives new blockchain code. While the blockchain system does not itself prevent copying, it allows copied material to be traced to its source. This can also flag that a copy is illegitimate and prevent, as it does some cryptocurrencies, an owner from transferring the digital IP more than once. The blockchain ensures the integrity of the digital IP as one, single unit within the owner's account.

Similarly, this concept can be used to verify sales of data. For example, the chain of hash function output created can provide a mechanism by which consumers could sell digital IP in much the same way they sell a used book or CD. In some cases, such digital transactions may require a payment be made to the original creator of the digital IP, such as royalty payment.

Consider another example. Technology already exists to watermark and timestamp lab notebooks and other digital IP records that include confidential information, where the timing and integrity of the creation is important. Blockchain records could be created each time the specific digital IP that is a lab notebook or other confidential document is accessed, copied, added to, read, and so on. Algorithms could be added that indicate the potential for lost IP, such as digital copying to personal drives, plagiarism by cut and paste or type copying, or even scroll-and-stop patterns that could indicate someone is photographing content off a computer screen. When such activity is detected, the IP document could be automatically closed pending verification of legitimate use.

In such a scenario, the IP documents could be configured such that to even access such IP documents, users would require an exchange of keys (private and/or public keys), such that the user provides their key for the right to view and handle sensitive documents from an individual or database with authority over the confidential documents. In such a configuration, even if the document left the authority's control and was spirited away in digital form outside the firewall, if could not be accessed without the proper hashtags key. In such configurations, if a change to the authority's key occurred, a legitimate user of the document would have the updated key instantly, but the illegitimate receiver, even if possessing the previous key, would be locked out upon receiving the document.

In some configurations, the owner of digital IP, for example, a photographer of a photograph, can change the settings on his artwork to allow legal sharing while still retaining the legal copyright. Depending on the configuration, chaining for legal copies can be automatic, such as when a creator does not want content shared without compensation, or it can be added/removed at a later time should the creator change their mind.

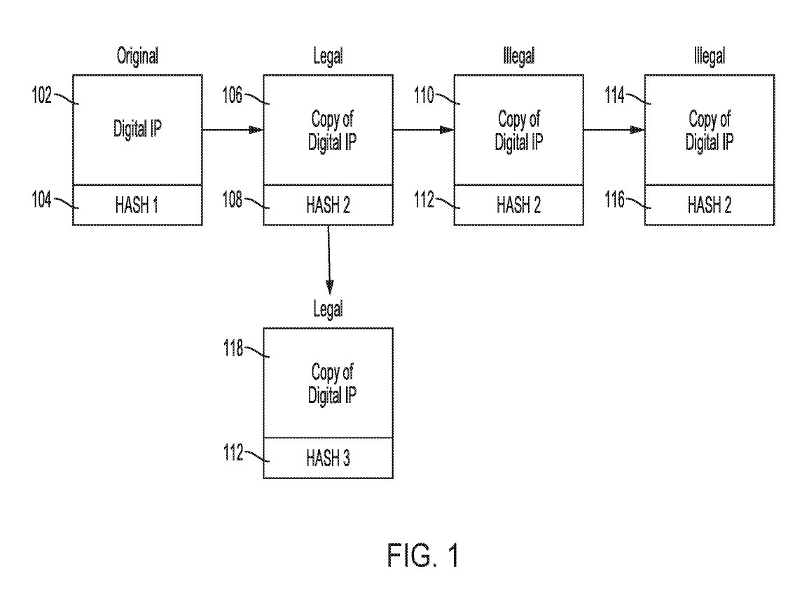

FIG. 1 illustrates an example of digital content being legally and illegally copied. In this example, an original piece of digital intellectual property (IP) 102 (such as a videos, music, books, articles, or other versions of copyrighted/trade secret information) is produced. The original piece of digital IP 102, as part of this system, is accompanied by a hash function output 104. To illustrate that this is the original piece of IP 102, the hash function output 104 is labeled “Hash 1.” The hash function output 104 can be, for example, the output of a hash function using, as input, the private key of the creator or owner of the digital content, as well as other pertinent information (such as the date, time, other permissions, etc.). The hash function output 104 can be added to the digital content 102 as a watermark or other record. For example, if the digital content 102 is a book, the hash function output 104 can be extra text added to the book record. If the digital content 102 is a video, the hash function output 104 can be embedded into various frames or other aspects of the digital encoding.

A legal copy of the digital IP 106 can be made using the private key of the owner, author, or other authorized individual. As discussed herein, the private key can be stored within a separate physical device, which is dual-verified both physically and digitally.

When a legal copy of the digital IP 106 is made, the digital content 102 is copied. However, a new hash 108 is produced. This hash function, and its resulting output 108, can be a combination of the previous hash 104, the private key of the authorizing individual, and/or other data (such as the time, date, etc.). This hash function output 108 is then similarly embedded into the IP. When further legal copies 118 are produced, those additional copies will have the same digital content 118, with updated hash function outputs 120 using the same process just described.

However, when illegal copies 110, 114 are produced, the corresponding/embedded hash function outputs 112, 116 will not be correct. Instead, the hash function outputs 112, 116 will either be (1) copies of the hash function output 108 of the legal copy 106 which was illegally copied (as illustrated), or (2) incorrect values which cannot be verified using private key or other information stored within the computer system. In either case, the fact that the hash function outputs 112, 116 are incorrect will make clear that these copies 110, 114 are illegal.

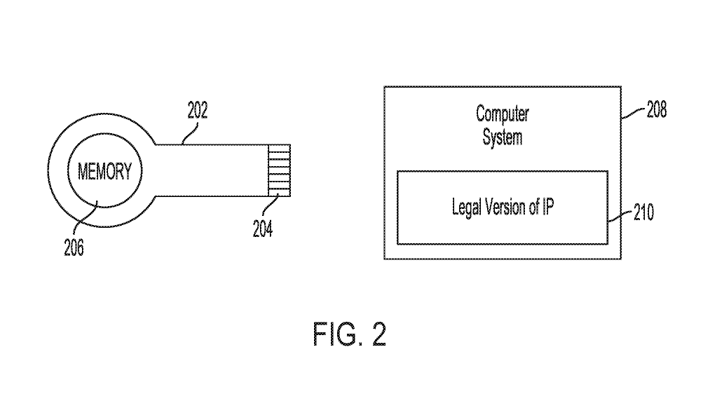

FIG. 2 illustrates a physical key with memory being used to access a legal version of intellectual property 210 (such as a videos, music, books, articles, or other versions of copyrighted/trade secret information). The legal version of the intellectual property 210 is stored in a computer system 208, examples of which include servers on “the cloud,” servers on a local area network (LAN), personal computers, smartphones, tablets, etc. A key 202 (or other object) containing non-transitory memory can be plugged into the computer system 208. In some configurations, the connectors 204 of the key 202 which are used to electrically connect the key 202 to the computer system 208 may be a USB (Universal Serial Bus) connector, a “Lightening Connector” for Apple™ systems, any other type of connector.

Consider the following example. A user has a legal copy of a movie 210 on their personal computer 208, and wishes to create a legal copy for their smartphone. The computer-system 208, prior to processing the request to duplicate the movie 210, requires the user to present a key 202 to the computer system 208, where the key 202 has the user's “private key” stored in memory 206. The private key is part of an asymmetrical cryptography system employed by the key 202 and the computer system 208, such as deployed in blockchain or other asymmetrical cryptography systems. The corresponding public key can be stored within the computer system.

When the computer system 208 detects the key 202, the computer system 208 first runs a verification to determine if the key 202 matches the physical description of the key 202 stored within the computer system 208. If the key 202 is essentially just a memory stick, the key might not have many distinguishing features. If, however, the key 202 physically functions as a rotating key (that is, has cuts which interact with tumblers and pins in a lock), or other functioning physical key, the computer system 208 may first require the key physically operate a lock, thereby completing a first verification of the key's authenticity.

After the first verification is complete, the computer system 208 may then perform a second verification, confirming that the private key stored within the memory 206 on the key 202 matches the private key associated with the user in the computer 208 database. Alternatively, because of the use of asymmetrical cryptography, rather than comparing an entirety of the number (and to further protect the private key of the user), the computer system 208 may compare a hash function output of the private key stored in the key 202 memory 206 to a previous hash function output of the user's private key, as stored in a database.

This double-verification system, where the key 202 is physically verified based on physical characteristics, then digitally verified based on the private key stored in the key's 202 memory 206, will likely deter many attempts to perform unauthorized duplication of intellectual property 210. However, even in those instances where illegal copies are produced, this system further provides security because when a legal copy is made, hash function output, which uses the user's private key information, can be saved as part of the duplication process. When an illegal copy is made, one of two things will happen. Either (1) the pirates will create an exact copy of the previously generated hashed output, allowing deduction of who the initial violator was, or (2) the pirates will create an invalid hashed output, allowing any verification process of the illegal copy's status to immediately provide notification that the copy is illegal. In this manner, the process for slowing down, or inhibiting, digital piracy of intellectual property will be improved. In this manner, the system can track the number of times the content is viewed (through legal copies) as well as attempts to illegally copy the content.

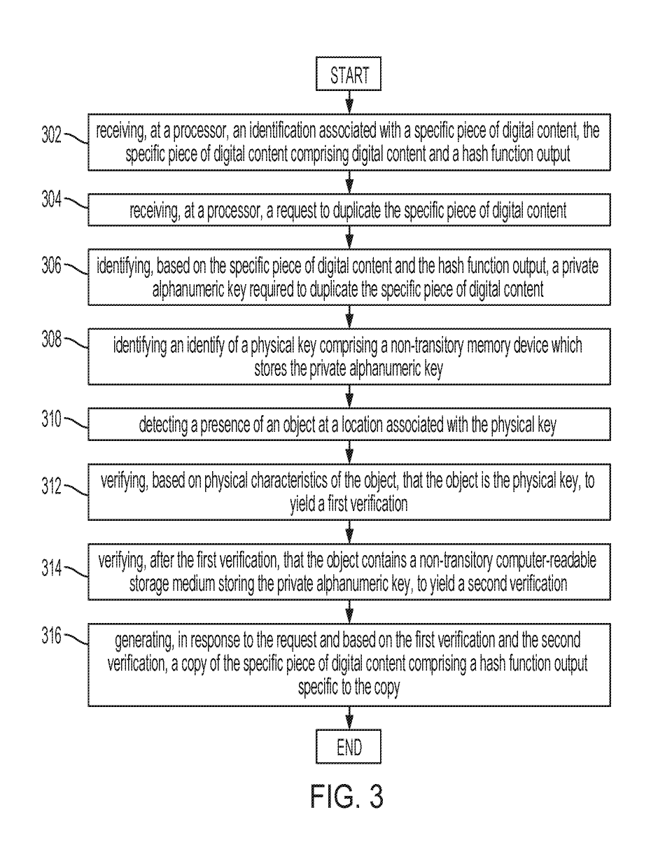

FIG. 3 illustrates an exemplary method embodiment. The steps outlined herein are exemplary and can be implemented in any combination thereof, including combinations that exclude, add, or modify certain steps.

An exemplary system configured according to this disclosure can receive, at a processor, an identification associated with a specific piece of digital content, the specific piece of digital content comprising digital content (such as video, audio, and/or text) and a hash function output (302), and receive, at the processor, a request to duplicate the specific piece of digital content (304). The system can identify, based on the specific piece of digital content and the hash function output, a private alphanumeric key required to duplicate the specific piece of digital content (306), and can also identify a physical key comprising a non-transitory memory device which stores the private alphanumeric key (308). The system can then detect a presence of an object at a location associated with the physical key (310), and verify, based on physical characteristics of the object, that the object is the physical key, to yield a first verification (312). Likewise, the system can verify (after the first verification) that the object contains a non-transitory computer-readable storage medium storing the private alphanumeric key, to yield a second verification (314), and generate, in response to the request and based on the first verification and the second verification, a copy of the specific piece of digital content comprising a hash function output specific to the copy (316).

The object can be (preferably) in the shape of a common key. The non-transitory computer-readable storage medium can be contained within the object, such that when the common key is used in accessing a computer system, the computer system can access the computer-readable storage medium contained within the object.

In some configurations, the physical characteristics of the object can include information such as the shape of the object, the size of the non-transitory computer-readable storage medium, and/or the weight of the object.

The method may, in some instances, be modified to further include: receiving biometric data from a possessor of the object, and verifying, prior to generating the copy, an identify of the possessor as authorized to perform duplications of the digital content. Non-limiting examples of the biometric data can include fingerprints, retinal scans, and palm scans.

Another exemplary way in which the method may be modified or augmented may include receiving location data from the object and confirming a position of the object based on the location data, to yield position confirmation, where the generating of the copy further requires the position confirmation. Non-limiting examples of location data include triangulation data, GPS (Global Positioning System) coordinates, or RFID (Radio Frequency Identification) data.

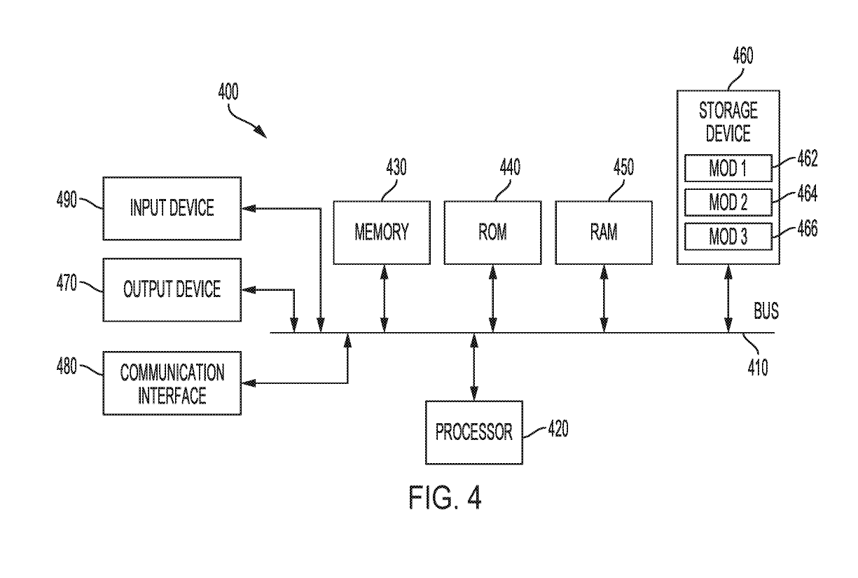

With reference to FIG. 4, an exemplary system includes a general-purpose computing device 400, including a processing unit (CPU or processor) 420 and a system bus 410 that couples various system components including the system memory 430 such as read-only memory (ROM) 440 and random access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1. A method comprising:
receiving, at a processor, an identification associated with a specific piece of digital content, the specific piece of digital content comprising digital content and a hash function output;
receiving, at the processor, a request to duplicate the specific piece of digital content;
identifying, based on the specific piece of digital content and the hash function output, a private alphanumeric key required to duplicate the specific piece of digital content;
identifying an identify of a physical key comprising a non-transitory memory device which stores the private alphanumeric key;
detecting a presence of an object at a location associated with the physical key;
verifying, based on physical characteristics of the object, that the object is the physical key, to yield a first verification;
verifying, after the first verification, that the object contains a non-transitory computer-readable storage medium storing the private alphanumeric key, to yield a second verification; and
generating, in response to the request and based on the first verification and the second verification, a copy of the specific piece of digital content comprising a hash function output specific to the copy.

2. The method of claim 1, wherein the digital content comprises at least one of video, audio, and text.

3. The method of claim 1, wherein the physical characteristics of the object comprise at least one of shape of the object, a size of the non-transitory computer-readable storage medium, and a weight of the object.

4. The method of claim 1, further comprising:
receiving biometric data from a possessor of the object; and
verifying, prior to generating the copy, an identify of the possessor as authorized to perform duplications of the digital content.

5. The method of claim 4, wherein the biometric data comprises at least one of a fingerprint, a retinal scan, and a palm scan.

6. The method of claim 1, further comprising:
receiving location data from the object; and
confirming a position of the object based on the location data, to yield position confirmation,
wherein the generating of the copy further requires the position confirmation.

7. The method of claim 6, wherein the location data comprises a Global Positioning System set of coordinates.

8. A system comprising:
a processor; and
a computer-readable storage medium having instructions stored which, when executed by the processor, cause the processor to perform operations comprising:
receiving an identification associated with a specific piece of digital content, the specific piece of digital content comprising digital content and a hash function output;
receiving a request to duplicate the specific piece of digital content;
identifying, based on the specific piece of digital content and the hash function output, a private alphanumeric key required to duplicate the specific piece of digital content;
identifying an identify of a physical key comprising a non-transitory memory device which stores the private alphanumeric key;
detecting a presence of an object at a location associated with the physical key;
verifying, based on physical characteristics of the object, that the object is the physical key, to yield a first verification;
verifying, after the first verification, that the object contains a non-transitory computer-readable storage medium storing the private alphanumeric key, to yield a second verification; and
generating, in response to the request and based on the first verification and the second verification, a copy of the specific piece of digital content comprising a hash function output specific to the copy.

9. The system of claim 8, wherein the digital content comprises at least one of video, audio, and text.

10. The system of claim 8, wherein the physical characteristics of the object comprise at least one of shape of the object, a size of the non-transitory computer-readable storage medium, and a weight of the object.

11. The system of claim 8, the computer-readable storage medium having additional instructions stored which, when executed by the processor, cause the processor to perform operations comprising:
receiving biometric data from a possessor of the object; and
verifying, prior to generating the copy, an identify of the possessor as authorized to perform duplications of the digital content.

12. The system of claim 11, wherein the biometric data comprises at least one of a fingerprint, a retinal scan, and a palm scan.

13. The system of claim 8, the computer-readable storage medium having additional instructions stored which, when executed by the processor, cause the processor to perform operations comprising:
receiving location data from the object; and
confirming a position of the object based on the location data, to yield position confirmation,
wherein the generating of the copy further requires the position confirmation.

14. The system of claim 13, wherein the location data comprises a Global Positioning System set of coordinates.

15. A non-transitory computer-readable storage medium having instructions stored which, when executed by a computing device, cause the computing device to perform operations comprising:
receiving an identification associated with a specific piece of digital content, the specific piece of digital content comprising digital content and a hash function output;
receiving a request to duplicate the specific piece of digital content;
identifying, based on the specific piece of digital content and the hash function output, a private alphanumeric key required to duplicate the specific piece of digital content;
identifying an identify of a physical key comprising a non-transitory memory device which stores the private alphanumeric key;
detecting a presence of an object at a location associated with the physical key;
verifying, based on physical characteristics of the object, that the object is the physical key, to yield a first verification;
verifying, after the first verification, that the object contains a non-transitory computer-readable storage medium storing the private alphanumeric key, to yield a second verification; and
generating, in response to the request and based on the first verification and the second verification, a copy of the specific piece of digital content comprising a hash function output specific to the copy.

16. The non-transitory computer-readable storage medium of claim 15, wherein the digital content comprises at least one of video, audio, and text.

17. The non-transitory computer-readable storage medium of claim 15, wherein the physical characteristics of the object comprise at least one of shape of the object, a size of the non-transitory computer-readable storage medium, and a weight of the object.

18. The non-transitory computer-readable storage medium of claim 15, having additional instructions stored which, when executed by the processor, cause the computing device to perform operations comprising:
receiving biometric data from a possessor of the object; and
verifying, prior to generating the copy, an identify of the possessor as authorized to perform duplications of the digital content.

19. The non-transitory computer-readable storage medium of claim 18, wherein the biometric data comprises at least one of a fingerprint, a retinal scan, and a palm scan.

20. The non-transitory computer-readable storage medium of claim 15, having additional instructions stored which, when executed by the processor, cause the computing device to perform operations comprising:
receiving location data from the object; and
confirming a position of the object based on the location data, to yield position confirmation,
wherein the generating of the copy further requires the position confirmation.
